(19) United States
(12) Patent Application Publication
(10) Pub. No.: US 2004/0016620 A1
(43) Pub. Date: Jan. 29, 2004

(54) Method for providing vendable items of entertainment

(76) Inventor: Melanee A. Davis, Taylorsville, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/601,736

(22) Filed: Jun. 23, 2003

Related U.S. Application Data
(60) Provisional application No. 60/392,686, filed on Jun. 28, 2002.

(51) Int. Cl. G07F 7/00

(52) U.S. Cl. 194/205

(57) ABSTRACT

Apparatus and methods are provided for dispensing new and/or used items of entertainment of the audio and/or visual and electronic type to travelers or other persons who encounter periods of waiting or delay, and the purchased item is accompanied by means that enable the purchaser to return the item for a monetary rebate or credit toward future item purchases. The present invention thereby provides travelers and others who wait with an economical means of entertaining themselves during periods of waiting and enables the purchaser to avoid having to keep and carry a weighty article or dispose of an otherwise expensive item of entertainment.

### CROSS-REFERENCE TO RELATED APPLICATION

This is a non-provisional application claiming priority to provisional application Serial No. 60/392,686 filed Jun. 28, 2002.

### BACKGROUND OF THE INVENTION

1. Field of the Invention

This invention relates to the vending of articles from a vending machine and specifically relates to methods for vending articles of entertainment such as books, magazines, DVD's and the like for potential reuse or recycling.

2. Description of Related Art

In the past few decades, people have become increasingly more mobile in society. Travel by air, train, bus and car has increased to an all-time high. Air travel has increased so much that an estimated 8-10 million people fly every year in the U.S. With the increase in air travel, however, have come innumerable delays experienced in getting to one's destination. Because travel has become so fraught with delays, travelers are seeking more and better forms of entertainment to keep themselves occupied during the long periods of waiting and traveling. Similarly, the delays and great expenditures of time associated with travel are also experienced in everyday life, such as waiting at doctor's appointments, attending people at hospital stays, waiting at laundry facilities, etc. People wish to occupy themselves during such periods of time and typically seek out any suitable means for entertaining themselves.

The principal form of entertainment to travelers, and others encountering long delays, is books. Every airport, train station and bus terminal has a bookstore or magazine stand from which books can be purchased before or during periods of travel. A preference exists for purchasing paperbacks over hardback books for the sake of lightweight travel. However, even paperback books, when finished, must be transported by the traveler through the remainder of his travel or must be disposed of along the route of travel. Cost-conscientious travelers complain about the cost of a paperback book, and yet the expense of the book influences whether it is purchased and how it is disposed of once it is read. That is, many travelers dislike spending a costly sum on a book just to throw it away in the interest of not having to tote the book with them through their travels.

In more recent years, with the increased use of personal computers and the ability to travel with laptops or notebook computers, an increasingly popular form of entertainment is movies that can be played on the DVD player installed in a laptop computer. Typically, travelers will plan ahead and bring one or more movies on DVD. However, there is an increasing trend to provide travelers with the ability to purchase or rent DVD's and to rent DVD players at airports to meet the demand for new, additional or better DVD's than what the traveler may have brought with him. One such purveyor of rentable DVD's, and DVD players, is InMotion Pictures of Jacksonville, Fla., which has rental booths established in a limited number of airports to rent movies and players. However, the person renting the player must be traveling to an airport that also has a company outlet so that the DVD player and rented DVD's can be returned.

Other companies simply sell DVD's in airports for use by travelers on their own DVD players. The same issue arises with respect to DVD's, however, as exists for purchased books; namely, how to decrease expenditures for purchasing new DVD's and what to do with the DVD after the DVD has been viewed. In a majority of cases, the purchaser does not want to keep the DVD or carry the DVD with him while traveling, yet does not want to simply throw the DVD away due to the significant cost of purchase.

In a somewhat similar industry, the problems of renting audiovisual articles (i.e., movies on videocassette) has been addressed in the video rental industry. Namely, several systems and methods have been devised for providing means by which persons can rent videotapes from an unmanned machine, such as a vending machine. Examples of such systems are described in U.S. Pat. No. 4,414,467 to Gould et al., U.S. Pat. No. 4,458,802 to Maciver, et al., U.S. Pat. No. 4,598,810 to Shore et al., U.S. Pat. No. 4,734,005 to Blumberg, U.S. Pat. No. 4,814,592 to Bradt, et al., U.S. Pat. No. 5,029,766 to Shah, U.S. Pat. No. 5,095,195 to Harman, et al., U.S. Pat. No. 5,159,560 to Newell, et al., U.S. Pat. No. 5,273,183 to Tuttobene and WIPO published application No. 89/0617. However, the systems disclosed in those patents contemplate that the videotape must be returned to the renting entity, and specifically to the machine which vended the videotape. Some vending rental systems further contemplate that a penalty will be assessed to a renter who does not return the rented videocassette.

The systems disclosed in the referenced patent literature do not address purchase or rental or articles of entertainment in situations where people are traveling or leaving the point of purchase and are unable to return the article to the machine from which it was purchased. Thus, it would be an advantage to provide a system for selling new and/or used books, magazines, DVD's, game DVD's or cassettes, audio CD's or any other conceivable form of entertainment device that can be economically purchased and economically disposed of, thereby enhancing the traveling or waiting experience.

### BRIEF SUMMARY OF THE INVENTION

In accordance with the present invention, apparatus and methods are provided for dispensing new and/or used items of entertainment of the audio and/or visual type to travelers or other persons who encounter periods of waiting or delay, and the purchased item is accompanied by means that enable the purchaser to return the item for a monetary rebate or credit toward future item purchases. The present invention thereby provides travelers and others who wait with an economical means of entertaining themselves during periods of waiting and enables the purchaser to avoid having to keep and carry, or dispose of, an otherwise expensive item of entertainment.

The system provides for the placement of vending apparatus at travel hubs, such as airports, train stations, bus terminals, road-side rest stops or the like, or at other areas where waiting is common, such as hospitals, medical clinics, doctor's offices, laundry facilities, health clubs, hair salons, etc. The vending apparatus is configured to display and vend new and/or used forms of audio and/or visual items of entertainment that may be purchased by consumers to occupy themselves during episodes of travel or waiting. The items of entertainment may be any number of products including, but not limited to, books (both paperback and hardback), cassette tapes (such as “books on tape”), compact discs (CDs), digital video discs (DVDs), game discs for use in DVD players or other game playing systems, current magazines or other periodicals, etc.

The vending apparatus is structured to process the purchaser's payment for the dispensed item of entertainment. The vending machine is, therefore, configured to accept money, credit cards, debit cards or pre-programmed and authorized payment or credit. The vending machine may, most suitably, be constructed to access electronic database systems, such as via a worldwide computer network system, to track accounting information for repeat purchasers. In such manner, repeat purchasers may be able to buy items of entertainment on accumulated credits for prior purchases.

Each item of entertainment is accompanied by a pre-addressed, postage pre-paid mailing envelope, or other postable device, and instructions to the purchaser instructing the purchaser how to return the purchased product to a designated collection point. The designated collection point may be a point of purchase of the item (such that the item is returned to a dispensing machine in the system) or a central warehouse from which the items are then returned to any one of a number of vending points in airports, train stations, hospitals, etc.

The purchaser may choose to keep the item and not return it. However, if the purchaser wishes to return the item, the purchaser can do so by placing the item in the mailing envelope provided with the item at the time of purchase. The purchaser simply follows the instructions provided with the item, namely inserting the item in the envelope provided and dropping the packaged item in the nearest mailbox. Alternatively, deposit boxes may be associated with the vending machines or may be provided at collection points away from the vending machines, and the purchaser may simply drop the item into the deposit box for re-processing.

Upon deposit of the item into a mailbox or designated collection device, the purchaser is able to request a refund of a portion of the fee spent to purchase the item or request a credit toward future purchases. A document may be provided with the item of entertainment at the time of purchase which the purchaser may use, upon return of the item, to notify the vendor of the information necessary to process the refund or credit. Refunds to the purchaser may be made by any suitable means, such as a cash refund sent to the purchaser via the mail, or by extending a credit on a credit card or on an electronic accounting system accessible by the purchaser. That is, the purchaser may access a website associated with the vending system to see a history of what has been purchased in the past and an accounting of what refunds or credits have been processed for that person's account. Access to the website may be accomplished at the vending machine site or on a person's own computer.

The vending machines of the present invention may, in addition to being configured to dispense items of entertainment, be configured to provide for the dispensing of articles related to enjoining the purchased items of entertainment, such as batteries, tape players, headphones, MP3 players, MP3 flashcards (pre-programmed), and other audio or video feedback devices or ancillary articles that fit within slots provided in the vending machine.

The vending machines of the present invention may further be configured with means for providing information about the system to provide purchasers with additional guidance in use, payment, return and accounting. For example, purchasers may be able to access a website or database from the vending machine that would inform the purchaser of the locations of other vending machines within airports and/or cities, a listing of the available titles and authors available through direct purchase or the ability to request to stock at the customer's requested location, customer account information, licensing business information, vendor information, and the like.

### BRIEF DESCRIPTION OF THE SEVERAL VIEWS OF THE DRAWINGS

In the drawings, which illustrate what is currently considered to be the best mode for carrying out the invention:

FIG. 1 is a schematic representation of a vending machine configured to provide items of entertainment for purchase; and

FIG. 2 is a schematic flow chart of the basic method of the invention by which purchasers can purchase and return items of entertainment.

### DETAILED DESCRIPTION OF THE INVENTION

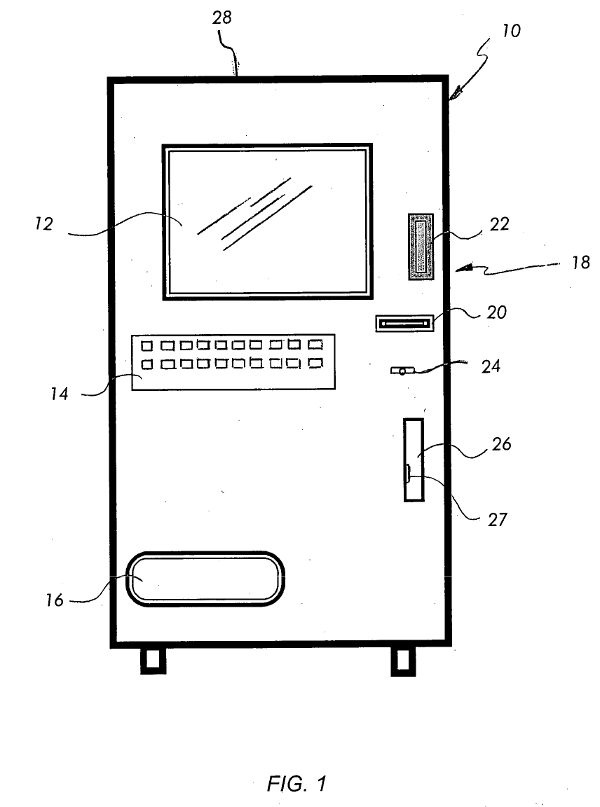

The present invention provides a means for purchasing new or used items of entertainment at selected points of purchase and further provides for the optional return of purchased items for partial refund or credit. FIG. 1 illustrates, by way of example, one exemplar dispensing apparatus 10 that may be used to carry out the present invention. In general, the dispensing apparatus 10 is structured with a display element 12 by which the prospective purchaser can view what items are available for purchase.

In one embodiment, the display element 12 may comprise a traditional mechanized array of holding devices that retain a plurality of items, such as books, DVD's and audiocassettes, in a manner similar to that of known snack food dispensing machines. Thus, the purchaser can view through a window the various items that are available for purchase and can select a desired item for dispensing. In such an embodiment, each item may be wrapped in a package, as described more fully below. The package may bear either a picture of the item, such as a copy of the commercial book cover or DVD jacket, or the package may be structured with a window so that the purchaser can view the article in a manner very similar to buying the article in a retail store.

A control panel 14 may be provided to allow the purchaser to indicate his selection and request dispensing of the item in a manner similar to known snack food or beverage vending machines. That is, each item of entertainment stocked in the dispensing apparatus 10 may be assigned a number or alphanumeric designation and the purchaser pushes a corresponding button or sequential number of buttons to trigger dispensing of the article. The article is then dispensed in a known manner to a delivery port 16 from where the purchaser retrieves the selected item.

In an alternative embodiment, the display element 12 may comprise a view screen or monitor on which is selectively displayed the inventory of items that can be dispensed from the dispensing apparatus 10. In such an embodiment, the control panel 14 may be a keyboard which the purchaser uses to access data and other information, and appropriate software enables a number of functions to be carried out. For example, the monitor of the display element 12 may provide the purchaser with instructions on how to scroll through a list of the items of entertainment that are available from the dispensing apparatus 10. If the purchaser sees an item of particular interest, the purchaser may, for example, click on the text or picture of that item and another screen display is enabled providing a view of what the item looks like in full size and giving a synopsis of what the item contains (i.e., a brief summary of the book or a listing of the tracks available on a CD, etc.) The purchaser can then enter a code or push a button on the keyboard to request dispensing of the item, which is delivered to the delivery port 16.

The item of entertainment must be paid for, in some manner, at the point of purchase. Thus, the dispensing apparatus 10 may be structured with at least one payment acceptance device 18. That is, the dispensing apparatus 10 may be structured with a money slot 20 through which, for example, paper money may be accepted. The money slot 20 may further be structured with a bill changer, as is known in the art, and may also include a coin slot for accepting currency tokens such as coinage or minted tokens made specifically for the dispensing apparatus. Further, the money slot 20, in tandem with the control panel 14 and appropriate software, may be configured to enable the purchaser to use the dispensing apparatus 10 as an automated teller machine (ATM) to access moderate amounts of cash to complete the purchase of the item.

The dispensing apparatus 10 may also be structured with a credit card acceptance device 22 which allows the purchaser to insert or “swipe” a credit card or debit card so that the charge may go directly to the purchaser's credit or debit account. The control panel 14 also provides structure for the purchaser to enter further information as may be required to charge the purchase of the item to a credit or debit card. The control panel 14 may also be used by the purchaser to access an established account with the system and to charge the purchase of the item against an accumulation of credit points existing on the established account.

The dispensing apparatus 10 may also be structured with a remote credit acceptance device 24, such as an electronic or infra red detector device that can remotely detect data contained on or within a device, such as a credit card, and process that data through the software of the dispensing apparatus 10 to complete the payment process. The dispensing apparatus 10 of the present invention can be structured with virtually any means for effecting payment for the item of entertainment to be purchased, and the illustrated devices shown in FIG. 1 are by way of example only.

As described more fully below, the dispensing apparatus 10 of the present invention may also be suitably structured to provide a means by which the purchaser of an item of entertainment can return the item to the system for the processing of a refund or credit toward future purchases. Therefore, the dispensing apparatus 10 may be structured with a deposit slot 26 through which an item of entertainment can be returned after use. The deposit slot 26 may, in one embodiment, be structured with an electronic device 27 for reading, for example, bar code information borne on the item or on an enclosure provided with the item that enables automatic acknowledgment of the return of the item and the automatic processing of a refund or credit.

The previously described elements of the dispensing apparatus 10 are each associated with a housing 28 which is appropriately sized for maintaining a selected inventory of items of entertainment, or ancillary products relating the such items of entertainment for their enjoyment, such as batteries, headsets, media players, etc. The housing 28 may be sized for placement in any number of venues where people typically experience delays or extended periods of waiting. Thus, for example, dispensing apparatus 10 may be located in airports, bus stations, train stations, medical venues such as clinics, hospitals or doctor's offices, hair salons, self-serve laundry facilities, etc. The size of the housing 28 may necessarily be selected to fit the venue, therefore.

The method of the present invention provides travelers or others who experience extended periods of waiting with the means for purchasing an item of entertainment to occupy themselves during the waiting period. The method, therefore, comprises providing a dispensing apparatus of the type previously described from which items of entertainment can be purchased. In accordance with the method of the present invention, the items are dispensed either with or in a packaging device which allows the purchaser to return the item to a designated location for a refund or credit toward future purchases.

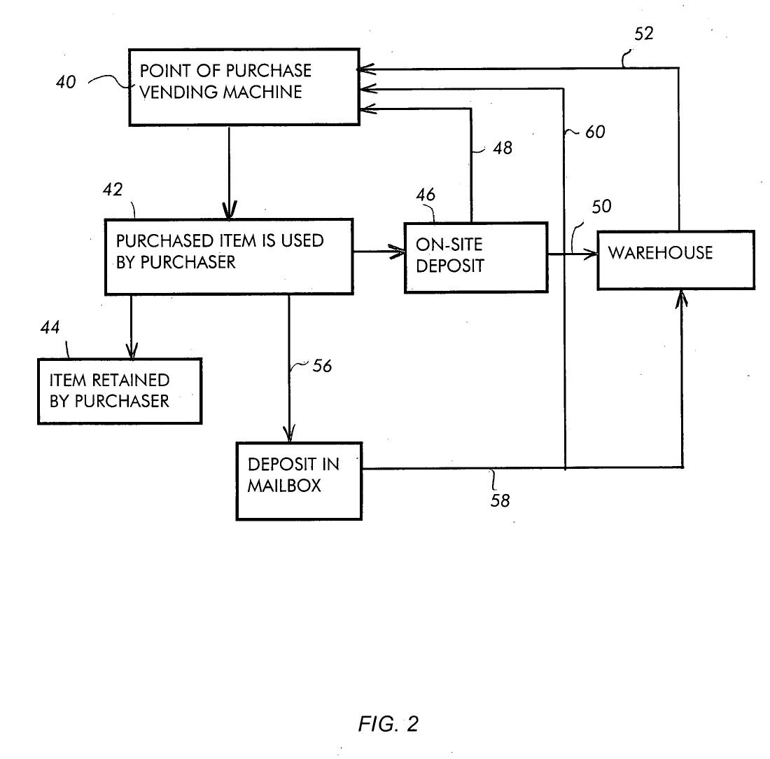

As illustrated schematically in FIG. 2, the method of the present invention comprises purchasing 40 an item of entertainment from a point of purchase, or vending machine as previously described. The item is then used or enjoyed by the purchaser 42. When the purchaser has used the item of entertainment to his satisfaction, the purchaser may then decide to either keep the item 44 or return the item for a partial refund or for credit toward future purchases. If the purchaser decides to return the item to the system, the purchaser may then choose one of two methods for return. First, the purchaser may return the item to an on-site deposit 46, such as inserting the item in the deposit slot 26 (FIG. 1) of a nearby dispensing apparatus 10, or deposit it in any other designated depository that is associated with the system (e.g., a drop box may be provided in grocery stores or malls, etc. where a dispensing apparatus is not otherwise available).

The item thus deposited on-site can either be returned to the particular vending machine 48 where the item was deposited, or the item can be processed for return to a central warehouse 50 from where the item is then returned 52 to one of the dispensing apparatus of the system. For the purposes of returning an item to an on-site depository (i.e., either a dispensing apparatus 10 or other deposit box), it may be suitable to provide the item of entertainment with electronically-readable indicia that is scannable by the dispensing apparatus 10 or other deposit box. In so doing, the on-site depository can automatically acknowledge return receipt of the item and initiate the processing of a refund or credit.

In an alternative method, the item can be placed in suitable packaging provided with the item at the time of purchase and the appropriately packaged item can then be deposited in the mail system 56 for return either to a central warehouse 58, from where the item is placed in a dispensing apparatus of the system 52, or the item can be returned directly to the point of purchase 60 for restocking.

In furtherance of returning the item through the mail system, the packaging that is provided with or around the item, most suitably, comprises a pre-addressed, postage-paid envelope sized to receive the item of entertainment. The envelope, most suitably, is pre-printed with the location to where the item will be returned (i.e., either the central warehouse or point of purchase). The packaging also preferably contains additional writing space or additional informational sheets that enable the purchaser to indicate where and how a refund or credit is to be processed. That information is then sent with the item through the mail and the refund or credit is processed in due course.

As noted previously, the item must be paid for at the time of purchase and the dispensing apparatus may be configured to accept any suitable means of payment. When an item is returned to the system, however, the purchaser is seeking a partial refund of the amount that was spent to purchase the item, or is seeking a credit toward future purchases. The means for processing such refunds or credits in accordance with the present invention are numerous. It should be noted, however, that the purchaser may not be entitled to a refund or credit, even though the item was returned, if the item is not in a condition for resale through the system of the present invention. A determination of whether the returned item can be processed through the system for resale is made either at a central warehouse or at the point of purchase when the dispensing apparatus is being restocked.

A refund or credit may be initiated, and in some instances completed, at the time the item is returned to an on-site depository. For example, when the item is returned to the on-site depository, the item may be scanned in by suitable electronic means associated with the depository device to acknowledge return receipt of the item. The user can then use the control panel or keyboard associated with the depository to further process the transaction of calculating a refund or credit. Thus, using the control panel or keyboard, the user can enter information about himself to assure a proper refund or credit to himself.

In one alternative, the user may be able to process an immediate refund of cash dispensed from the dispensing apparatus. Alternatively, the user may enter data when prompted to request that a cash refund be mailed to him at a given address. Alternatively, the user may enter data when prompted that will process a credit to the purchaser's established account, thereby enabling him to apply such credit to future purchases of items through the system. In another alternative method, the user may enter data when prompted that will process a credit to his credit card or debit card.

The dispensing apparatus may further be configured with appropriate software and hardware that enables a purchaser to access his account electronically at the point of purchase. Thus, the purchaser may view his established account with the systems and determine how much credit he has toward making a new purchase. The present invention also includes website means by which a purchaser may access his account at any time and through any device.

The apparatus and methods of the present invention provide means by which persons can economically and easily purchase items of entertainment and then return those items so that the person does not have to carry the item around or be made the permanent owner of the item. The dispensing apparatus of the invention is structured to display the vendable items, to receive payment, to receive returned items and to process and/or access information relating to the refunding for or crediting of returned items. The methods of invention enable the processing of refunds and credits, and the accessing of account information by purchasers through any number of means. Thus, the apparatus and methods described herein can be modified to fit any venue and to facilitate any means for the return of purchased items for refund or credit, and reference herein to specific details of the illustrated embodiments is by way of example and not by way of limitation. It will be apparent to those skilled in the art that many modifications of the basic described embodiments may be made without departing from the spirit and scope of the invention as recited by the claims.

What is claimed is:

1. A method for providing to persons who experience periods of delay or waiting returnable items of entertainment, comprising:
providing dispensing apparatus structured to selectively dispense at least one item of entertainment with pre-addressed, postage-paid return indicia;
purchasing a said item of entertainment from said dispensing apparatus;
depositing said item of entertainment for return following use of said item of entertainment; and
processing a refund or credit in response to the return of said item of entertainment.

2. The method according to claim 1 further comprising providing said pre-addressed, postage-paid indicia on an enclosure sized to receive said item of entertainment and placing said item of entertainment in said enclosure for return.

3. The method according to claim 1 further comprising providing access to account information for monitoring purchases and credits or refunds.

4. The method according to claim 1 wherein said purchasing of said item of entertainment is effected by insertion of money into said dispensing apparatus.

5. The method according to claim 1 wherein said purchasing of said item of entertainment is effected by insertion of tokens into said dispensing apparatus.

6. The method according to claim 1 wherein said purchasing of said item of entertainment is effected by electronically accessing and processing a credit card via said dispensing apparatus.

7. The method according to claim 1 wherein said purchasing of said item of entertainment is effected by electronically accessing and processing a debit card via said dispensing apparatus.

8. The method accordingly to claim 1 wherein said depositing of said item of entertainment is effected by placing said item of entertainment in an on-site depository associated with said dispensing apparatus.

9. The method according to claim 1 wherein said depositing of said item of entertainment is effected by placing said item of entertainment in a postal receiving depository for return in accordance with said pre-addressed indicia.

10. The method according to claim 1 further comprising receiving said item of entertainment in a warehouse following depositing of said item for return, and processing said returned item of entertainment for restocking in said dispensing apparatus.

11. The method according to claim 1 wherein said processing of a refund or credit comprises accepting input data into said dispensing apparatus upon deposit of said item of entertainment to said dispensing apparatus, acknowledging receipt of said item and determining an amount of refund or credit allowed to the purchaser.

12. The method according to claim 11 further comprising the refund of cash by said dispensing apparatus.

13. The method according to claim 11 further comprising the electronic crediting of a determined sum to an established purchaser account.

14. The method according to claim 13 further comprising processing said electronic crediting to initiate a cash refund for postal delivery.

15. The method according to claim 11 further comprising the electronic crediting of a determined sum to a credit card.

16. The method according to claim 1 wherein said processing of a refund or credit comprises entering into a database system data provided with the return of said item of entertainment through postal delivery services thereby acknowledging receipt of said item and determining an amount of refund or credit allowed to the purchaser.

17. The method according to claim 16 further comprising the crediting of a determined sum to an established purchaser account for application against future purchases.

18. The method according to claim 16 further comprising processing said crediting to initiate a cash refund for postal delivery.

19. The method according to claim 16 further comprising the crediting of a determined sum to a credit card.

20. A dispensing apparatus for providing items of entertainment and related articles in venues where delays or waiting is experienced, comprising:
a housing sized for retaining a selected inventory of vendable items of entertainment and related articles;
a display element for viewing at least a portion of said selected inventory of vendable items retained within said housing;
a control panel for use in selecting a said item of entertainment for vending from said housing;
at least one payment acceptance device; and
a delivery port for receiving a selected item of entertainment vended from said housing.

21. The dispensing apparatus of claim 20 further comprising a deposit slot for receiving a returned item of entertainment.

22. The dispensing apparatus of claim 21 wherein said deposit slot is configured with electronic apparatus for sensing and processing data borne on said item of entertainment enabling acknowledgment of return of said item.

23. The dispensing apparatus of claim 20 wherein said display element is an electronic monitor capable of displaying selected information relating to said items of entertainment.

24. The dispensing apparatus of claim 20 wherein said control panel further comprises a keyboard providing for entry of data.

25. The dispensing apparatus of claim 20 wherein said at least one payment acceptance device comprises a money slot sized to receive currency.

26. The dispensing apparatus of claim 20 wherein said at least one payment acceptance device comprises a coin slot sized to receive currency tokens.

27. The dispensing apparatus of claim 20 wherein said at least one payment acceptance device comprises a credit card acceptance device.

28. The dispensing apparatus of claim 20 wherein said at least one payment acceptance device comprises an electronic remote sensing device for receiving wireless signals from a generating device providing payment information.
